(19) United States
(12) Patent Application Publication
(10) Pub. No.: US 2005/0289539 A1
(43) Pub. Date: Dec. 29, 2005

(54) Central installation, deployment, and configuration of remote systems

(76) Inventor: Sudhir Krishna S, Bangalore (IN)

Correspondence Address: FISH & RICHARDSON, P.C., PO BOX 1022, MINNEAPOLIS, MN, 55440-1022, US

(21) Appl. No.: 10/879,963

(22) Filed: Jun. 29, 2004

(51) Int. Cl. G06F 9/445

(52) U.S. Cl. 717/177

(57) ABSTRACT

A system for installing one or more components at one or more remote locations from a central location is provided. The system includes a parent site, which may include a transceiver and a repository. The system also includes a first child site, which may include a first web service to receive a first communication from the transceiver indicating that a first application is stored in the repository, to retrieve the first application from the repository, and to configure the first application at the first child site. Some implementations may enable connectors to be installed, configured, and/or upgraded at multiple remote sites from a central location once a web-services program is installed at each remote site. This may make administering an enterprise easier, which may lead to reduced maintenance costs.

### TECHNICAL FIELD

This document relates to installing, configuring, and/or updating remote components from a central location.

### BACKGROUND

Many enterprises have multiple offices in various parts of the world. Often, each office has multiple servers that allow workers to perform their tasks. Some examples include enterprise resource planning (ERP) applications, customer resource management (CRM) applications, supplier resource management (SRM) applications, corporate Intranets, corporate workflow applications, business-to-business (B2B) commerce applications, the Internet, or Groupware applications (such as Microsoft Outlook or Lotus Domino), among other applications.

These enterprises often desire the multiple servers at each remote site to be integrated with corresponding servers at the enterprise headquarters. Integration requires communication between the corresponding servers. When the remote sites are located on different continents, this communication becomes difficult because the available bandwidth is often insufficient to handle the high volume of information transfer required for the enterprise's needs.

To cope with the bandwidth limitations, enterprises often install connectors at each site that allow compressed communication between the enterprise headquarters and each of the remote sites. This may involve manual installation and maintenance of each connector at each remote site. Such an installation/maintenance scheme may require the enterprise to employ one or more administrators who are familiar with the distinctive characteristics of each remote site to install, deploy, and configure the remote connectors. Also, whenever one of these connectors must be upgraded to a newer version, the administrator(s) may be required to travel to the remote sites and perform the upgrade. This results in high maintenance costs and increases the possibility of human error.

### SUMMARY

This document describes systems and methods for deploying, configuring, and upgrading remote components from a central location. In one aspect, a system for installing one or more components on computers at one or more remote locations from a computer at a central location. The system includes a component repository to store a first component to be installed on a first remote computer located at a first remote site.

The system also includes an instruction module to notify the first remote computer that the first component is stored in the component repository and to instruct the first remote computer to retrieve the first component from the component repository. The system also includes a repository interface to receive a request for the first component from the first remote computer, to retrieve the first component from the component repository, and to provide the first component to the first remote computer.

The system may also include a confirmation module to receive a communication from the first remote computer indicating whether the first component was successfully installed. The system may also include a user interface through which an operator can control the instruction module. The system may also include a web service parameter repository to store one or more parameters of a remote web service. The system may also include a web service parameter interface to receive notification from the remote web service of the remote web service's one or more parameters and to store the one or more parameters in the web service parameter repository. The system may also include a parameter change notification module to notify the first remote computer when a location parameter of a central computer changes.

The first component may be a connector that enables communication between a central computer and a data source application located at the first remote site. The data source application may be a groupware server or an enterprise resource planning system. The first component may also be an upgrade to a connector.

The component repository may be able to store a second component to be installed on a second remote computer located at a second remote site. Also, the instruction module may be able to notify the second remote computer that the second component is stored in the component repository and to instruct the second remote computer to retrieve the second component from the component repository. Also, the repository interface may be able to receive a request for the second component from the second remote computer, to retrieve the second component from the component repository, and to provide the second component to the second remote computer. The second component may be a substantial duplicate of the first component.

In a second aspect, a system for installing one or more components on computers at one or more remote locations from a computer at a central location is provided. A communication module receives an instruction from a central computer to install a component on a remote computer at a remote site. A retrieving module retrieves the component from the central computer. An execution module installs the component on the remote computer.

The system may also include a component repository to store components located at a remote site and a verification module. The verification module may receive a communication from the communication module identifying the component, determine whether the component is stored in the component repository, and direct the communication module to notify the central computer whether the remote computer needs the component. The system may also include a component repository in which the execution module may store the component in the component repository after the execution module installs the component.

The verification module may direct the retrieving module to retrieve the component from the central computer. The communication module may notify the central computer whether the component was successfully installed.

The component may be a connector that enables communication between the central computer and a data source application located at the remote site. The data source application may be a groupware server or an enterprise resource planning system. The first component may also be an upgrade to a connector.

Additionally, the communication module may have one or more location parameters. The communication module may notify the central computer of the location parameters. The central computer may also have one or more location parameters. The communication module may receive notification from the central computer when the one or more location parameters change.

In a third aspect, a method for installing one or more components at one or more remote locations from a central location is provided. The method may include several features. One feature may involve receiving a first communication from a parent site that a first application is stored in a repository, retrieving the first application from the repository, and configuring the first application.

The method may also involve additional features. One additional feature may involve transmitting a communication to the parent site indicating whether the first application was successfully configured. Another may involve communicating the connector's location parameters to the parent site. Another may involve verifying that the first application is not already configured before retrieving the first application from the repository. Still another may involve notifying the parent site of the location to which the parent site may transmit communications before receiving the first communication from the parent site that the first application is stored in the repository. Another may involve receiving notification from the parent site of the repository's location before retrieving the first application from the repository.

The method may also involve receiving a second communication from the parent site that a second application is stored in the repository, the second application being different from the first application. Further, another feature may involve retrieving the second application from the repository. Still another feature may involve configuring the second application. The first application may include a connector that enables communication between the parent site and a data source application at a remote location and the second application may include an updated version of the connector.

Additionally, the first application may include an updated version of an already-configured connector that enables communication between the parent site and a data source application at a remote location. Further, the first communication may comprise a SOAP message.

In a fourth aspect, a method for installing one or more components at one or more remote locations from a central location is provided. The method may involve placing an application in a repository, notifying a first web service located at a first child site that the application is in the repository and is available for retrieval and configuration, and verifying that the first web service successfully retrieved and configured the application.

The method may involve additional features. One feature may involve installing the first web service at the first child site. Another may involve receiving a communication comprising the first web service's location parameters. Still another may involve notifying the first child site of the repository's location before receiving verification that the first web service successfully retrieved and configured the application. Another may involve receiving notification of the location of the first web service before notifying the first web service that the application is in the repository and is available for retrieval and configuration.

The method may also involve notifying a second web service located at a second child site that the application is in the repository and is available for retrieval and configuration, the second child site being different from the first child site and receiving verification that the second web service successfully retrieved and configured the application.

The first web service may include a user interface generating a communication in response to a user's command. The communication may include a SOAP message. The application may include a connector that enables communication between a central location and a data source application at the child site. Also, the application may include an updated version of a connector that is already configured at the child site, the connector being capable of enabling communication between a central location and a data source application at the child site.

Advantageously, after a web service is installed at each remote site, components may be installed, configured, and/or upgraded at multiple remote sites from a central or single location. This makes administering an enterprise easier, which leads to reduced maintenance costs. Additionally, because installation, configuration, and/or upgrading are performed automatically, rather than by human administrators, errors are reduced, resulting in greater enterprise efficiency.

The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of an enterprise communication system with multiple remote sites.

FIG. 2 is a system for installing or upgrading components at remote sites from a central site.

FIG. 3 is an exemplary user interface that may be used in conjunction with the system shown in FIG. 2.

FIG. 4 is a flowchart of installing/upgrading remote components from a central location shown from the central site's perspective.

FIG. 5 is a flowchart of installing/upgrading remote components from a central location shown from the remote site's perspective.

Like reference symbols in the various drawings indicate like elements.

### DETAILED DESCRIPTION

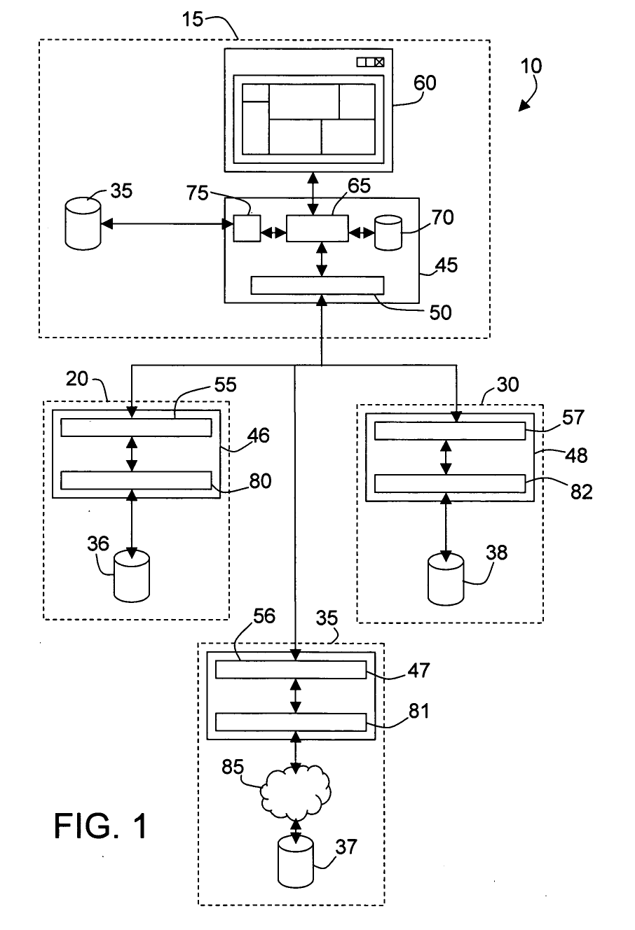

FIG. 1 is a block diagram of an enterprise communication system 10 with multiple remote sites. Four sites are shown: a central site 15 and three remote sites 20, 25, 30. Information from various data sources 35-38 may be integrated or mirrored on a central computer 45. Data sources 35-38 may include ERP applications, CRM applications, SRM applications, corporate Intranets, corporate workflow applications, B2B commerce applications, the Internet, or groupware applications (such as Microsoft Outlook or Lotus Domino), among other applications. There may be different numbers and kinds of data sources at each site. For example, nested sites are possible. A site may include the components necessary to function as a child site with respect to one site and as a parent site with respect to one or more sites.

The central computer 45 may retrieve information from the central data source 35 located at the central site 15 directly or indirectly, such as through a network like a LAN or the Internet. The central computer 45 may also retrieve information from the data sources 36-38 that are located at the remote sites 20, 25, 30 directly or indirectly.

Generally, however, direct communication in a standard application protocol can be slow if bandwidth is limited between sites. Thus, a central connector 50 may be implemented at the on the central computer 45, and remote connectors 55-57 may be implemented on remote computers 46, 47, 48 located at respective remote sites 20, 25, 30. The connectors enable software developers to focus on developing the primary functionality of the application rather than spending time and money trying to make sure the client application can interact with every conceivable application with which the client application may eventually interact. Once the developer creates the primary functionality, any person can create the object that allows for interoperability. Connectors must adhere to the defined interface and messages for communication like install, configure, and so on. The functionality of each connector may vary from one system to another. For example, in one system, the connectors may fetch files and folders located in a file store, while another set of connectors may fetch data from a database.

The connectors 50, 55-57 may allow for communication between the central computer 45 and the remote computers 46-48 in a protocol that uses less bandwidth. One example of such a protocol is Simple Object Access Protocol (SOAP), which uses Hypertext Transfer Protocol (HTTP) and Extensible Markup Language (XML) as the mechanisms of information exchange. This communication may also be secure to prevent unauthorized persons from accessing the potentially sensitive material being communicated.

Many different implementations for allowing communication between a central computer 45 and remote computers 46-48 via connectors 50, 55-57 are possible. For instance, as shown, a user may request information of the central computer 45 through a portal 60. A communication module 65 may be included in the central computer 45. The communication module 65 may be responsible for ensuring reliable and effective communication between the central computer 45 and other components. The communication module 65 may receive requests from the portal 60 and determine to which data source 35-38 the requests should be directed. The communication module 65 may compare the requests received from the portal 60 with information stored in a data source repository 70. The data source repository 70 may include information concerning which data sources 35-38 contain what type of data. The communication module 65 may then determine to which data source 35-38 the requests should be directed. The communication module 65 may determine that the request should be directed to more than one data source 35-38.

If the communication module 65 determines that a request should be directed to the local data source 35, the communication module 65 transmits the request to a local retriever 75. The local retriever 75 may be responsible for retrieving information from the local data source 35. The local retriever 75 may retrieve the requested information from the local data source 35 and transmit it back to the communication module 65, which may transmit it back to the portal 60 for display.

If the communication module 65 determines that a request should be directed to a remote data source 36-38, the communication module 65 transmits the request to the central connector 50. Suppose, for example, the communication module 65 determined that a request received from the portal 60 should be directed to the data source 36 located at remote site 20. The central connector 50 would receive the request from the communication module 65, compress the request, and transmit the compressed request to the remote connector 55 on remote computer 46. The remote connector would decompress the request and transmit the decompressed request to a remote retriever 80. The remote retriever 80 may retrieve information corresponding to the request from the data source 36 and transmit the information to the remote connector 55. As a side note, the remote retrievers 80-82 may interact indirectly with the remote data sources 36-38. As shown, the remote retriever 81 communicates with data source 37 through a network, such as a LAN or a WAN. Referring back to the example, the remote connector 55 may compress the requested information and transmit it to the central connector 50. The central connector 50 may decompress the requested information and transmit it to the communication module 65, which may transmit the requested information back to the portal 60.

There are many other alternatives for implementing remote communications systems that use connectors. For example, although one data source 35-38 is shown at each site 15-30, a site 15-30 may have many or no data sources 35-38. In fact, as is common in industry, each remote site may have all of the different types of data sources listed above. The central computer 45 and the remote computers 46-48 may have a connector for each data source application.

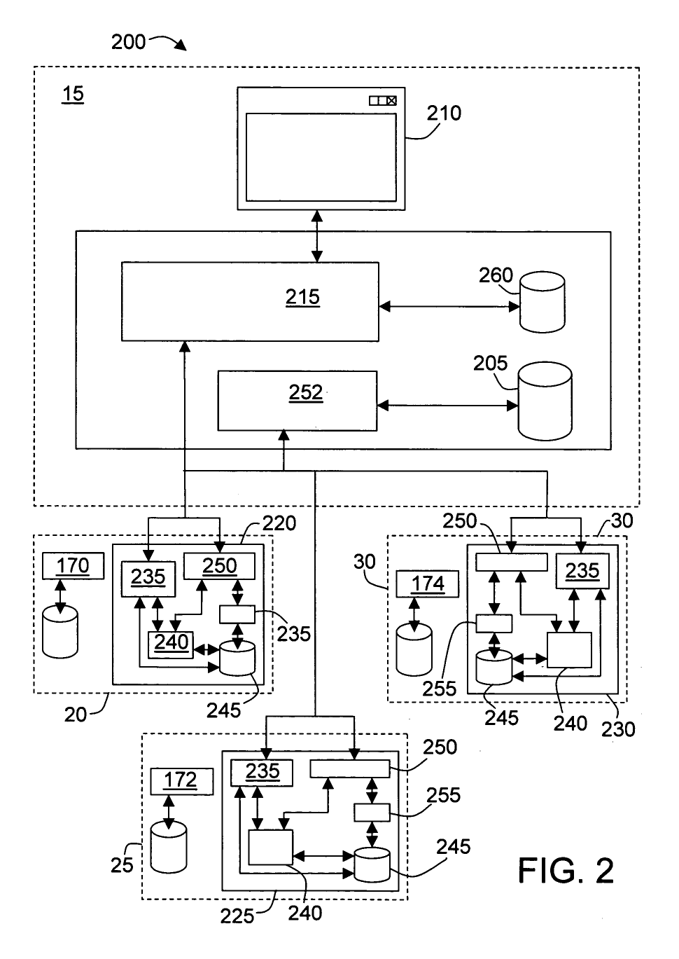

FIG. 2 is a system 200 for installing or upgrading components at remote sites 20-30 from a central site 15. Such components may include connectors or other appropriate applications or objects. The installing/upgrading system 200 may include a central computer 45, which may include a repository 205. An administrator may store one or more scripts in the repository 205. The repository 205 may provide secure storage for the scripts. The scripts may correspond to a new component to be installed at one or more remote sites 20-30. The scripts may also correspond to a new version of a component to be installed at one or more remote sites 20-30. The remote sites 20-30 may already have the new version of that component, may have an older version of that component, or may not have that component at all.

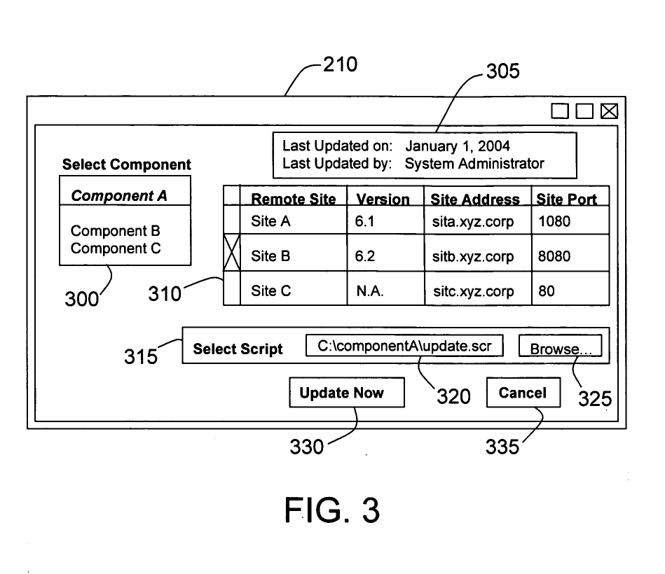

The installing/upgrading system 200 may also include a user interface 210 that includes components for displaying an underlying application that allows an administrator to initiate the installing or upgrading of remote components. FIG. 3 shows the user interface 210 in more detail. In the installing/upgrading system 200 of FIG. 2, an administrator may enter a command to install or upgrade one or more components at one or more remote sites 20-30. Once the administrator enters a command, the application associated with the user interface 210 generates a communication corresponding to the command and transmits the communication to the central computer 45.

The central computer 45 may include an instruction module 215 that is responsible for notifying remote sites 20-30 when new or upgraded components are available and for instructing those remote sites 20-30 to retrieve those components from the repository 205. The instruction module 215 receives communications from the application associated with the user interface 210, analyzes the communications, and relays the communications to the appropriate remote sites 20-30. The communication from the application associated with the user interface 210 may include, among other things, information associated with the type and/or version of the component to be installed or upgraded and information associated with the remote sites at which the component will be installed or upgraded. The instruction module 215 may initiate communication with the appropriate remote site or sites and transmit the content of the communication received from the application associated with the user interface 210 to that remote site or those remote sites. The instruction module 215 may also instruct the remote site or sites 20-30 to retrieve the appropriate script from the repository 205. The instruction module's 215 communication with the remote site or sites may occur after the administrator has stored one or more scripts in the repository 205. Thus, the remote sites 20-30 do not inquire from the central site 15 whether new or updated components exist. Rather, the central site 15 notifies the remote sites 20-30 when and if new or updated components exist.

At the remote sites 20-30, web services 220-230 may handle the installing and upgrading responsibilities. Web services 220-230 may be, for example a collection of functions that are packaged as a single entity and published to a network for use by other programs. Web services 220-230 may be identified by uniform resource identifiers. Each web service 220-230 may include a communication module 235 for receiving communications from the instruction module 215 and setting the install/upgrade process into motion. The communication module 235 may analyze the communication and determine what version of what component has been stored in the repository 205.

The communication module 235 may then communicate the component and the version to a verification module 240. The verification module 240 may be responsible for verifying that the remote site 20-30 needs the component. The verification module 240 may search through a component repository 245, which may store the remote site's 20-30 components, to determine whether that version of that component is already installed on the remote site 20. If the verification module 240 determines that the component repository 245 already contains the version of the component, the verification module 240 may direct the communication module 235 to notify the instruction module 215. If the verification module 240 determines that the component repository 245 does not contain the version of the component, the verification module 240 may notify a retrieving module 250.

The retrieving module 250 may be responsible for retrieving the component from the central computer 45. The retrieving module 250 may receive the notification from the verification module 240 and formulate a communication to retrieve the script that corresponds to the version of the component about which the remote site 20-30 has been instructed. The communication may be in a compressed format to avoid the bandwidth limitations referenced above. SOAP may be an appropriate format. Then the retrieving module 250 may transmit the communication to an interface 252 that communicates with the repository 205. The interface 252 may request the script from the repository 205, and the repository 205 may respond with the appropriate script. The interface 252 may then send a responsive communication containing the script to the retrieving module 250. The responsive communication may also be in a compressed format such as SOAP.

When the retrieving module 250 retrieves the script from the repository 205, the retrieving module 250 may transmit the script to an execution module 255. The execution module 255 may be responsible for configuring the retrieved component. The execution module 255 may execute the script, which may configure the component and prepare it for communication. Then the execution module 255 may transmit the component to the component repository 245. The component repository 255 may notify the communication module 235 of the component's location parameters. The communication module 235 may communicate the component's location parameters and whether the installation/upgrade was successfully performed to the instruction module 215. The instruction module 215 may store those component location parameters in a location parameter repository 260, which may be located at the central site 15.

This process of installing and/or upgrading remote components may take place in a trusted environment. Unauthorized persons may be prevented from accessing the contents of the communications. Such persons may also be prevented from introducing viruses or other harmful communications into the system 200. Virus detecting software may be installed at each site to ensure such a trusted environment.

Although this implementation has been described as having several distinct components for each install/upgrade operation, the installing/upgrading system 200 may be arranged in any appropriate manner. For example, two or more of the components could be combined, or additional components could be provided. In addition, the order of, and interrelationships between, the various components could be rearranged.

FIG. 3 is an exemplary user interface 210 that may be used in conjunction with the system shown in FIG. 2. The user interface 210 allows an administrator to initiate the installing or upgrading of remote components. The user interface 210 allows an administrator to select a component from a component list 300. The component list 300 may include components to be installed at remote locations or any other suitable software application or item. As shown, the administrator has selected component A. In response to an administrator's selection of a component from the component list, the user interface may display information in several views 305-315.

The history view 305 may display when and by whom the selected component was last updated. As shown, component A was updated on Jan. 1, 2004 by the System Administrator. The remote site view 310 may display a list of various remote sites and some attributes of those sites. The attributes listed may include the version of the selected component being run at each site and each site's address and port. As shown, remote site C does not have component A, so the remote site view 310 displays “N.A.” The attributes listed may also include a notation of whether the site needs to be upgraded. As shown, an “X” in the first column indicates that Site B does not need to be upgraded.

The script view 315 may provide an input field 320 into which the administrator may enter the script to be executed at the remote sites. The administrator may enter the appropriate script manually or by browsing through the repository. The administrator may browse by actuating the browse button 325.

Once the administrator has entered the appropriate script in the input field 320, the user may actuate an “Update Now” button 330. This may trigger the process described in conjunction with FIGS. 3, 5-6. If the administrator decides not to initiate the install/upgrade process, he or she may actuate a “Cancel” button 335.

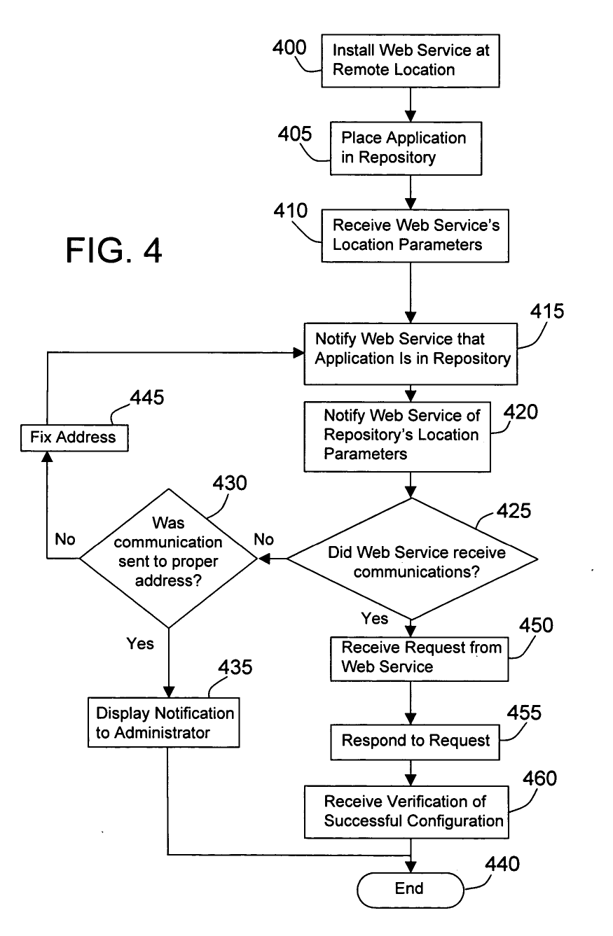

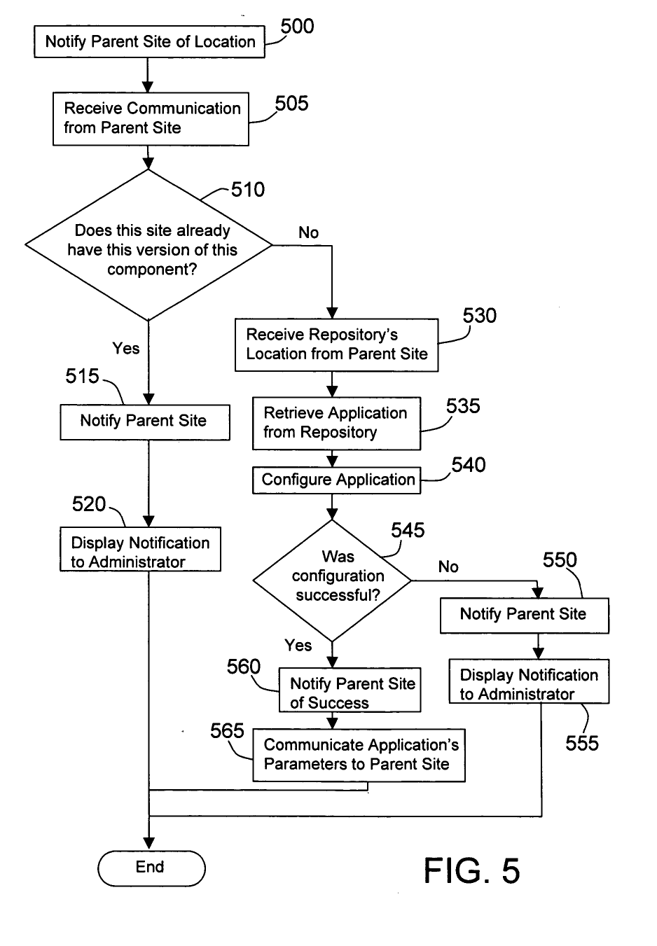

FIGS. 4 and 5 are flowcharts of installing/upgrading remote components from a central location. FIG. 4 shows the process from the central site's perspective, and FIG. 5 shows the process from the remote site's perspective.

In FIG. 4, an administrator installs a web service at a remote site in block 400. The administrator may accomplish this installation by going to the remote site and manually installing the web service, by script using the operating system's native capabilities where available, or by any other appropriate method. The administrator may install a web service at several remote sites before moving on to the next step.

At block 405, the administrator has placed an application in a repository located at the central site. The application may include a script or any other appropriate items. The script may be a simple batch file, shell commands, java applications, or other appropriate scripts. The administrator could also store the script in the repository (block 405) before installing any web services (block 400).

At block 410, the central site receives the location parameters of the web service installed in block 400. When the administrator installs the web service in block 400, he or she may provide the web service with the central site's location parameters, allowing the web service to initiate communication with the central site. Thus, a newly-installed web service may register its location parameters with the central site. This step may also be performed before storing the script in the repository (block 405).

Once the central site knows the location parameters of the remote site, the central site may communicate with the remote site. The central site may notify the web service of the remote site that an application is in the repository at the central site, as indicated by block 415. Additionally, the central site may notify the web service of the remote site of the repository's location parameters, as indicated in block 420. The central site may load the path, script information, and location of the application and then converts this information into an install/upgrade SOAP message. Then, the central site may authenticate against the remote site. After successful authentication, the central site may send the notification. Blocks 415 and 420 could be combined into one block, could be reversed in order, and could occur before an administrator places a script in the repository (block 405).

Once the central site transmits the communications indicated by blocks 415 and 420, the central site may inquire whether the web service received the communications, as indicated by block 425. The central site may do so by asking the web service to send a confirmation response, by waiting for an error message, or by any other appropriate means. If the web service did not receive the communications, the central site may determine whether the communications were sent to the proper address, as indicated in block 430. If the communications were sent to the proper address, the central site may display an error message to the administrator, as indicated in block 435, thus ending the process 440. If the communications were sent to the wrong address, the central site may fix the address, as indicated in block 445, and re-send the communications indicated by blocks 415 and 420.

If the central site determines, in block 425, that the web service did receive the communications, the central site may receive a request from the web service for the application stored in the central site repository, as indicated in block 450. The central site may respond to that request by providing the application to the web service, as indicated by block 455. Once again, these communications may be in a compressed format, such as SOAP, and may occur in a trusted environment. Once the central site provides the application to the web service, the central site may receive confirmation from the web service that the application was successfully configured at the remote site, as indicated in block 460, thus ending the process 440.

FIG. 5 is a flowchart of installing/upgrading remote components from a central location shown from the remote site's perspective. The remote web service first notifies the central site of the remote web service's location parameters, as indicated in block 500. This may be done any time after installation of the web service and before the first communication from the central site. Once the remote web service has notified the central site of the remote web service's location parameters, the remote web service may receive a communication from the central site, notifying the remote web service that an application is in the central site repository and directing the remote web service to retrieve and configure the application, as indicated in block 505.

When the remote web service receives the communication, indicated by block 505, regarding the application in the central site repository, the remote web service may determine whether the remote web service already has that application, as indicated in block 510. If the remote site already has that application, the remote web service may notify the central site, as indicated in block 515. The central site may display the notification to the administrator, as indicated in block 520, thus ending the process 525.

If the remote web service determines, in block 510, that the remote site does not already have the application stored in the central site repository, the remote web service may receive the central site repository's location parameters from the central site, as indicated in block 530. Block 530 may also occur before, or at the same time as, block 505. Once the remote web service knows the location parameters of the central site repository, the remote web service may retrieve the application from the central site repository, as indicated in block 535, and configure that application at the remote site, as indicated in block 540.

Once the remote web service configures the application at the remote site, the remote web service may determine whether the configuration was successful, as indicated in block 545. If configuration was not successful, the remote web service may notify the central site, as indicated in block 550. The central site may display an error message to the administrator, as indicated in block 555, thus ending the process 525.

If the remote web service determines, in block 545, that configuration was successful, the remote web service may notify the central site that configuration was successful, as indicated in block 560. The remote web service may also notify the central site of the newly-configured application's location parameters, as indicated in block 565, thus ending the process 525. At this point, the central site would be able to interact with the newly-configured application at the remote site.

As used in this document, the term “computer” means a device, or multiple devices working together, that accepts information (in the form of digitalized data) and manipulates it for some result based on a program or sequence of instructions on how the data is to be processed. A computer may also include the means for storing data for some necessary duration.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made and that other implementations are within the scope of the following claims.

1. A system for installing one or more components on remote computers at one or more remote locations from a central computer at a central location comprising:
a component repository at the central location to store a first component to be installed on a first remote computer located at a first remote site;
an instruction module to notify the first remote computer that the first component is stored in the component repository and to instruct the first remote computer to retrieve the first component from the component repository; and
a repository interface to receive a request for the first component from the first remote computer, to retrieve the first component from the component repository, and to provide the first component to the first remote computer.

2. The component installation system of claim 1, further comprising a confirmation module to receive a communication from the first remote computer indicating whether the first component was successfully installed.

3. The component installation system of claim 1, wherein the first component comprises a connector that enables communication between a central computer and a data source application located at the first remote site.

4. The component installation system of claim 3, wherein the data source application comprises a groupware server.

5. The component installation system of claim 3, wherein the data source application comprises an enterprise resource planning system.

6. The component installation system of claim 1, wherein the first component comprises an upgrade to a connector that enables communication between a central computer and a data source application located at the first remote site

7. The component installation system of claim 1, wherein the component repository is operable to store a second component to be installed on a second remote computer located at a second remote site,
the instruction module is operable to notify the second remote computer that the second component is stored in the component repository and to instruct the second remote computer to retrieve the second component from the component repository; and
the repository interface is operable to receive a request for the second component from the second remote computer, to retrieve the second component from the component repository, and to provide the second component to the second remote computer.

8. The component installation system of claim 7, wherein the second component is a substantial duplicate of the first component.

9. The component installation system of claim 1, wherein the instruction module is operable to use a SOAP message to notify the first remote computer that the first component is stored in the component repository and to instruct the first remote computer to retrieve the first component from the component repository.

10. The component installation system of claim 1, further comprising a user interface through which an operator can control the instruction module.

11. The component installation system of claim 1, further comprising a web service parameter repository to store one or more parameters of a remote web service.

12. The component installation system of claim 11, further comprising a web service parameter interface to receive notification from the remote web service of one or more parameters of the remote web service, and to store the one or more parameters in the web service parameter repository.

13. The component installation system of claim 1, further comprising a parameter change notification module to notify the first remote computer when a location parameter of a central computer changes.

14. A system for installing one or more components on computers at one or more remote locations from a central computer at a central location comprising:
a communication module to receive an instruction from a central computer to install a component on a remote computer at a remote site;
a retrieving module to retrieve the component from the central computer; and
an execution module to install the component on the remote computer.

15. The component installation system of claim 14, further comprising:
a component repository to store components located at a remote site; and
a verification module to receive a communication from the communication module identifying the component, to determine whether the component is stored in the component repository, and to direct the communication module to notify the central computer whether the remote computer needs the component.

16. The component installation system of claim 15, wherein the verification module is operable to direct the retrieving module to retrieve the component from the central computer.

17. The component installation system of claim 14, further comprising a component repository, wherein the execution module is operable to store the component in the component repository after the execution module installs the component.

18. The component installation system of claim 14, wherein the component comprises a connector that enables communication between the central computer and a data source application located at the remote site.

19. The component installation system of claim 18, wherein the data source application comprises a groupware server.

20. The component installation system of claim 18, wherein the data source application comprises an enterprise resource planning system.

21. The component installation system of claim 14, wherein the component comprises an upgrade to a connector that enables communication between the central computer and a data source application located at the remote site.

22. The component installation system of claim 14, wherein the communication module is operable to notify the central computer whether the component was successfully installed.

23. The component installation system of claim 14, wherein the instruction comprises a SOAP message.

24. The component installation system of claim 14, wherein the communication module has one or more location parameters and the communication module is operable to notify the central computer of the location parameters.

25. The component installation system of claim 14, wherein the central computer has one or more location parameters and the communication module is operable to receive notification from the central computer when the one or more location parameters change.

26. A method for installing one or more components on computers at one or more remote locations from a computer at a central location comprising the steps of:
receiving a first communication from a parent site that a first application is stored in a repository;
retrieving the first application from the repository without user intervention; and
configuring the first application without user intervention.

27. The component installation method of claim 26, further comprising transmitting a communication to the parent site indicating whether the first application was successfully configured.

28. The component installation method of claim 26, wherein the first application comprises a connector that enables communication between the parent site and a data source application at a remote location, the connector having one or more location parameters.

29. The component installation method of claim 28, further comprising communicating the connector's location parameters to the parent site.

30. The component installation method of claim 28, wherein the data source application comprises a groupware server.

31. The component installation method of claim 28, wherein the data source application comprises an enterprise resource planning system.

32. The component installation method of claim 26, further comprising verifying that the first application is not already configured before retrieving the first application from the repository.

33. The component installation method of claim 26, further comprising notifying the parent site of the location to which the parent site may transmit communications before receiving the first communication from the parent site that the first application is stored in the repository.

34. The component installation method of claim 26, further comprising receiving notification from the parent site of the repository's location before retrieving the first application from the repository.

35. The component installation method of claim 26, wherein the first application comprises an updated version of an already-configured connector that enables communication between the parent site and a data source application at a remote location.

36. The component installation method of claim 26, further comprising:
receiving a second communication from the parent site that a second application is stored in the repository, the second application being different from the first application;
retrieving the second application from the repository; and
configuring the second application.

37. The component installation method of claim 36, wherein the first application comprises a connector that enables communication between the parent site and a data source application at a remote location and the second application comprises an updated version of the connector.

38. The component installation method of claim 26, wherein the first communication comprises a SOAP message.

39. A computer-implemented method for installing one or more software components at one or more remote locations from a central location comprising the steps of:
placing an application in a repository;
notifying a first web service located at a first child site that the application is in the repository and is available for retrieval and configuration, the first web service having one or more location parameters; and
receiving verification that the first web service successfully retrieved and configured the application.

40. The method of claim 39, further comprising:
notifying a second web service located at a second child site that the application is in the repository and is available for retrieval and configuration, the second child site being different from the first child site; and
receiving verification that the second web service successfully retrieved and configured the application.

41. The method of claim 39, further comprising:
installing the first web service at the first child site; and
receiving a communication comprising the first web service's location parameters.

42. The method of claim 39, wherein notifying the first web service comprises a user interface generating a communication in response to a user's command.

43. The method of claim 42, wherein the communication comprises a SOAP message.

44. The method of claim 39, wherein the application comprises a connector that enables communication between a central location and a data source application at the child site.

45. The method of claim 44, wherein the data source application comprises a groupware server.

46. The method of claim 44, wherein the data source application comprises an enterprise resource planning system.

47. The method of claim 39, wherein the application comprises an updated version of a connector that is already configured at the child site, the connector being capable of enabling communication between a central location and a data source application at the child site.

48. The method of claim 39, further comprising notifying the first child site of the repository's location before receiving verification that the first web service successfully retrieved and configured the application.

49. The method of claim 39, further comprising receiving notification of the location of the first web service before notifying the first web service that the application is in the repository and is available for retrieval and configuration.
